(19) United States
(12) Patent Application Publication
(10) Pub. No.: US 2025/0306317 A1
(43) Pub. Date: Oct. 2, 2025

(54) OPTICAL COUPLING DEVICE WITH ALIGNMENT FEATURES

(71) Applicant: Intel Corporation, Santa Clara, CA (US)

(72) Inventors: Peter A. Williams, Phoenix, AZ (US); Darren Vance, Gilbert, AZ (US); Sufi R. Ahmed, Chandler, AZ (US)

(73) Assignee: Intel Corporation, Santa Clara, CA (US)

(21) Appl. No.: 18/622,627

(22) Filed: Mar. 29, 2024

(51) Int. Cl. G02B 6/42

(52) U.S. Cl. CPC G02B 6/4292; G02B 6/4243; G02B 6/425; G02B 6/428

(57) ABSTRACT

An apparatus comprising at least one rigid portion; a plurality of optical channels, wherein a portion of the plurality of optical channels are secured within the at least one rigid portion, the plurality of optical channels comprising first ends extending from the at least one rigid portion; wherein the at least one rigid portion comprises a groove in a surface of the at least one block.

### GOVERNMENT RIGHTS

This Invention was made with Government support under Agreement No. N00164-19-9-0001, awarded by NSWC Crane Division. The Government has certain rights in the Invention.

### BACKGROUND

High-speed optical interconnects are crucial to meet the continuously increasing data rate demands of modern data centers and computing systems. Computing components may be packaged with optical interfaces to enable them to communicate over high-speed optical interconnects rather than traditional electrical interconnects. An optical interface typically includes a photonic integrated circuit (PIC) to send and receive optical signals over optical channels.

### BRIEF DESCRIPTION OF THE DRAWINGS

FIG. 1 illustrates an optical coupling device with alignment features, in accordance with any of the embodiments disclosed herein.

FIG. 2 illustrates a perspective view of the optical coupling device, in accordance with any of the embodiments disclosed herein.

FIG. 3 illustrates a side view of the optical coupling device, in accordance with any of the embodiments disclosed herein.

FIG. 4 illustrates another perspective view of the optical coupling device, in accordance with any of the embodiments disclosed herein.

FIGS. 5A-5E illustrate views of a lower block of an optical coupling device, in accordance with any of the embodiments disclosed herein.

FIGS. 6A-6E illustrate views of an upper block of an optical coupling device, in accordance with any of the embodiments disclosed herein.

FIG. 7 illustrates a front view of the optical coupling device, in accordance with any of the embodiments disclosed herein.

FIG. 8 illustrates a pick head with features to mate with alignment features of an optical coupling device, in accordance with any of the embodiments disclosed herein.

FIG. 9 illustrates a bottom view of an optical coupling device with alignment features and a slot, in accordance with any of the embodiments disclosed herein.

FIG. 10 illustrates a top view of the optical coupling device of FIG. 9, in accordance with any of the embodiments disclosed herein.

FIG. 11 illustrates a top view of an optical coupling device aligned with a photonic integrated circuit, in accordance with any of the embodiments disclosed herein.

FIG. 12 illustrates a system comprising an optical coupling device, in accordance with any of the embodiments disclosed herein.

FIG. 13 provides a schematic illustration of a cross-sectional view of an example integrated circuit device, in accordance with any of the embodiments disclosed herein.

FIG. 14 is a top view of a wafer and dies that may be included in a microelectronic assembly, in accordance with any of the embodiments disclosed herein.

FIG. 15 is a cross-sectional side view of an integrated circuit device that may be included in a microelectronic assembly, in accordance with any of the embodiments disclosed herein.

FIG. 16 is a cross-sectional side view of an integrated circuit device assembly that may include a microelectronic assembly, in accordance with any of the embodiments disclosed herein.

FIG. 17 is a block diagram of an example electrical device that may include a microelectronic assembly, in accordance with any of the embodiments disclosed herein.

### DETAILED DESCRIPTION

High-speed optical interconnects are crucial to meet the continuously increasing data rate demands of modern data centers and computing systems. For example, computing components (e.g., processors, accelerators, field programmable gate arrays (FPGAs), switches, memory/storage, other application specific integrated circuit (ASIC) nodes) may be packaged with optical interfaces to enable them to communicate over high-speed optical interconnects rather than traditional electrical interconnects. An optical interface typically uses a photonic integrated circuit (PIC) to send and receive optical signals over optical channels.

A PIC may be connected to an optical coupling device, such as a fiber array unit (FAU) or optical coupler, that uses a plurality of optical channels (e.g., waveguides or optical fibers) to communication optical signals with corresponding optical channels of the PIC. For example, an FAU may comprise an array of optical fibers to communicate optical signals with corresponding waveguides of the PIC. When a fiber array unit is connected to a PIC, the fibers of the fiber array unit must be precisely aligned with the waveguides of the PIC to mitigate insertion loss and enable communication between the PIC and the fiber array unit. Typically, this alignment is performed visually. The fiber array unit may be measured to find the center point of the fibers (e.g., along the X and Y axes) and the height of the fibers (e.g., along the Z axis). The rotation about the X, Y, and Z axes may also be measured and used as an alignment starting position. Such measurement may be tedious and time consuming. Use of edges of the block (e.g., glass block) of the FAU as a reference is problematic due to dimension variability caused by fracturing of the glass when the block is formed.

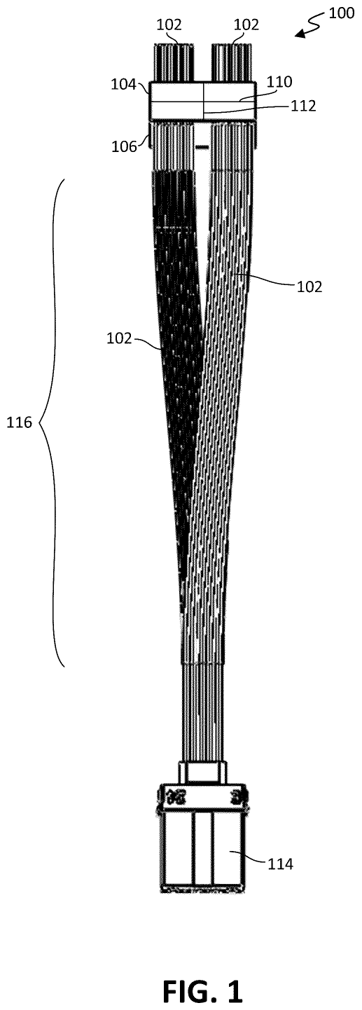

FIG. 1 illustrates an optical coupling device 100 with alignment features (e.g., 110 and 112), in accordance with any of the embodiments disclosed herein. In the embodiment shown, the optical coupling device 100 comprises an FAU. In various embodiments, the alignment features may include kinematic features on the top and/or bottom surfaces of at least one portion (e.g., block) of the FAU and/or fiducials (e.g., visual indicators) that provide alignment datums for pickup and/or final positioning of the optical fibers with respect to the waveguides (e.g., within V-grooves of the PIC die). The alignment features may enable self-alignment of the FAU in the X and Y directions to the pick head of a tool that is used to align the FAU to the PIC. Adequate self-alignment in the Z direction may also be achieved through tight control of the thickness of an upper block 104 of the device 100. Thus, various measurements (e.g., of the X, Y, and/or Z position of the FAU) may be omitted as the FAU may automatically align to the center rotations of a gripper arm.

If an alignment feature (e.g., 110) perpendicular to the fibers is formed (e.g., etched) before the FAU is assembled, then the alignment feature will provide a reference for the fiber tip length (the length of the fiber tips extending from the FAU is important to ensure that the fibers are close enough to the waveguides of a PIC attached to the FAU) during a polish or grind step performed on the fiber tips (e.g., after a coarse cut is performed). The alignment features may also provide a reference point for the center of the fiber array, which may then be used, e.g., to align the fibers with waveguides of a PIC the device is to attach to.

Various embodiments may also provide a location to position and pivot the FAU when the FAU also includes alignment features (e.g., grooves) on the bottom side, thus supporting optical assembly regardless of a physical attachment to the lower surface. The optical device can also slide on surface attachment during expansion of the lower surface without impacting the optical connection.

Various embodiments of the present disclosure may provide technical advantages, such as one or more of faster passive assembly for non-rigid fibers of an optical coupling device such as an FAU or rigid optical channels, improved assembly methods for an optical interface, or more accurate alignment of an optical coupling device and a PIC.

The device 100 includes an array of optical fibers 102. The fibers 102 may comprise any material (e.g., silica) suitable to communicate an optical signal. The fibers 102 may be single-mode or multimode fibers. The fibers 102 are disposed between at least one rigid portion such as an upper block 104 and a lower block 106. While blocks are shown as being generally rectilinear herein, the shapes of the blocks are not limited thereto. The fibers may be aligned between the blocks 104 and 106 with the appropriate spacing between adjacent fibers and proper orientation (e.g., by being placed within grooves of one or both of the blocks and/or being secured to the blocks, e.g., through an adhesive). The fibers may include coating (e.g., an acrylic coating) over a portion 116 of the fibers, while other portions may omit this coating (and thus the bare fiber may be exposed). For example, the portion of the fibers that is encased by the blocks 104 and 106 and the portions that extend out from the blocks may be bare. The fibers 102 may be coupled to the blocks 104 and 106 proximate a first end (where bare fibers 102 extend outward from the blocks) and may be coupled to a connector 114 (e.g., a mechanical transfer (MT) ferrule) at a second end.

Connector 114 may comprise a multi-fiber connector to align and protect multiple fibers. The connector may comprise a rigid material, e.g., ceramic, metal, plastic, or glass. The connector 114 may enable a connection (e.g., via alignment pin holes) between the fibers 102 and an optical device connected to connector 114. The connector 114 may connect to any suitable optical device (e.g., another PIC, a processor, a network interface controller (NIC), a storage, a memory, an I/O device, another integrated circuit, another optical connector, etc.), such as another computing component that is included in the same package or in an external device or system.

Upper block 104 may comprise a rigid material. In one embodiment, upper block 104 comprises glass. In various embodiments, the upper block 104 may be transparent (e.g., to allow for ultraviolet (UV) curing of epoxy adhesive used to connect the upper block 104 to the fibers 102 and/or the lower block 106). Lower block 106 may also comprise a rigid material. In various embodiments, lower block 106 may comprise the same material as the upper block or a different material. In one embodiment, the lower block 106 comprises a metal alloy, such as Kovar (which may or may not be plated with a conductive material, such as gold).

As depicted, the upper block 104 includes alignment features 110 and 112. Alignment feature 112 is substantially parallel to the portions of the fibers 102 extending from (and/or encased within) the blocks and alignment feature 110 is substantially perpendicular to the same portions of the fibers 102. In various embodiments, the lower block 106 may include similar alignment features (or may omit alignment features).

In some embodiments, the alignment features may be kinematic features formed by removing material from the respective block. For example, as shown in various FIGS., the alignment features may comprise grooves (e.g., V-shaped grooves) formed on a surface of a block (e.g., a top surface of the upper block 104 or a bottom surface of the lower block 106). The alignment features are shown in more detail in the subsequent FIGS.

In other embodiments, the kinematic features may be any suitable geometric features that may mate with features of a tool that connects to the device 100 (e.g., to align the fibers 102 of the device 100 to waveguides of a PIC). For example, the kinematic features may include recesses on the respective surfaces. In one example, a kinematic feature may include one or more shallow recesses on a surface with a cross section of any suitable shape (e.g., a V-shape as shown, a U-shape (e.g., a rectilinear cross section), a semicircular shape, etc.), while the corresponding interface of the tool may have a corresponding protrusion on its surface (e.g., with a V-shape, a U-shape, a semicircular shape, etc.) that are designed to mate with the recesses on the surfaces of the block.

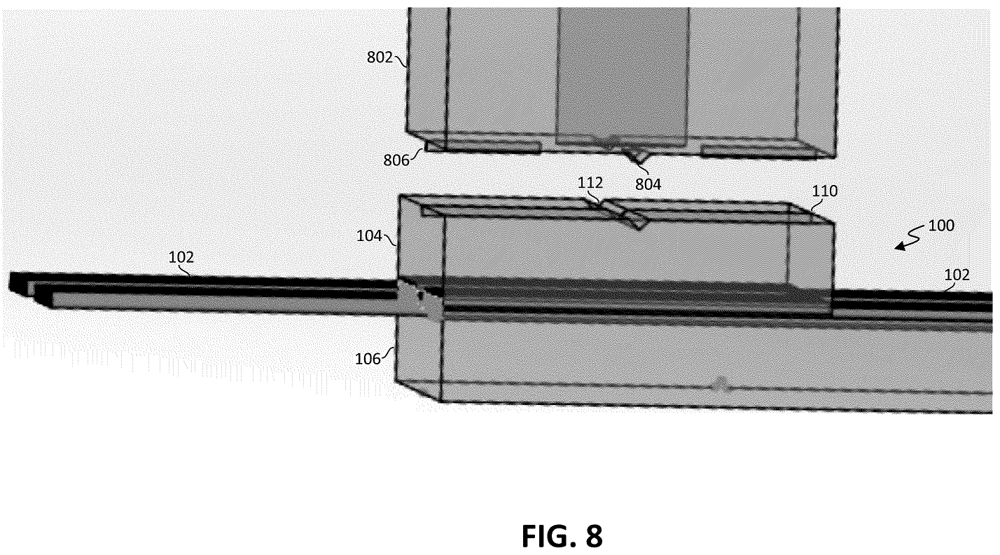

As an example, FIG. 8 illustrates a pick head 802 of a pickup tool. The pick head 802 includes features 804 and 806 to mate with alignment features 110 and 112 of optical coupling device 100. In this embodiment, the features 804 and 806 are V-shaped protrusions formed on the bottom surface of the pick head 802. The bottom surface of the pick head 802 and the features 804 and 806 may be placed against the top surface of block 104 and the alignment features 110 and 112 when the device 100 is picked up to be aligned to a PIC.

The pickup tool may be capable of picking up the device 100, manipulating the position of the device 100 along the x, y, and z axes, and rotating the device 100 about any of these axes to position the fibers 102 in a desired position (e.g., in line with waveguides of a PIC). In some embodiments, the pickup tool may utilize a vacuum to contact a surface (e.g., top or bottom surface of the upper or lower block) and/or a mechanical (e.g., pneumatic) gripper to grip the sides of the at least one block of the device 100.

In various embodiments, the PIC may implement testing loops for use during alignment. Optical signals may be communicated through waveguides to one or more fibers and received back on one or more fibers. The position of the device 100 may then be adjusted (e.g., by the pickup tool) until suitable amounts of light are detected by the PIC, indicating proper alignment.

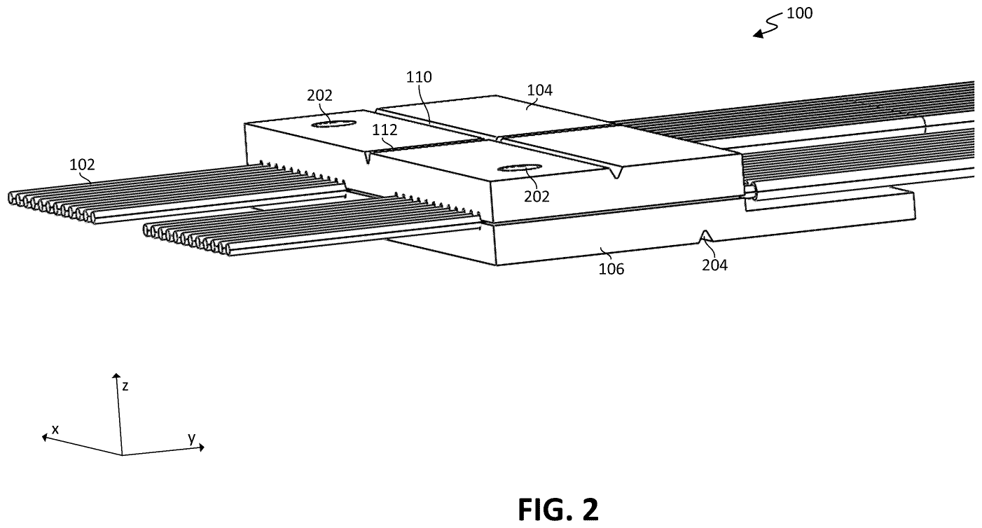

FIG. 2 illustrates a perspective view of the optical coupling device 100, in accordance with any of the embodiments disclosed herein. This FIG. illustrates the alignment features 110 and 112 in greater detail. In this embodiment, the alignment features 110 and 112 each span across the entire surface of the upper block 104 from a respective side to a respective opposite side. For example, feature 110 spans across the block in the x-direction and the feature 112 spans across the block in the y-direction. In other embodiments, a feature may span only a portion of a surface of a block.

In the embodiment depicted, the features are depicted as straight lines that span the surface of the block in the x-y plane. In other embodiments, the features could have other suitable shapes (e.g., within the x-y plane). For example, the features could collectively form a rectilinear shape instead of the collective cross shape shown. As another example, the features could collectively form an X-shape (where the features extend diagonally across the surface) or an L-shape.

In the embodiment depicted, the feature 112 that is parallel to the fibers 102 is positioned in the center of the fibers 102 (in the x-direction). For example, the distance from the center of the feature 112 to the center of the furthest fiber 102 in one direction along the x-axis may be equal to the distance from the center of the feature 112 to the center of the furthest fiber 102 in the opposite direction along the x-axis. In other embodiments, the feature 112 may be offset from such a center. Similarly, feature 110 may be in the center of the upper block 104 (in the y-direction) or offset from the center.

In the embodiment depicted in FIG. 2, alignment features 202 are also depicted. These features are shown as having an oval shape, although any suitable shape may be used. In some embodiments, these features may be fiducials that are used to coarsely align the pick head 802 (or other tool that is to pick up the device 100) with the device 100 (e.g., using computer vision). In some embodiments, features 202 may be formed on the surface of the upper block 104 (or within the body of the upper block 104) and may be visually distinct from other portions of the upper block 104 so the tool may align to the alignment features 202.

This view also depicts an alignment feature 204 on the lower block 106. The alignment feature 204 is shown as a V-shaped recess formed on the bottom surface of the lower block 106. The alignment feature 204 may be parallel to the alignment feature 110 (and thus perpendicular to the fibers 102). In various embodiments, alignment features on the lower block 106 may interface with a support that has a corresponding feature (e.g., a ridge if the alignment feature is a groove) and may provide force feedback for coarse Z-height using force feedback. In various embodiments, the feature on the lower block may be used to make assembly easier. For example, a support (e.g., on an integrated heat spreader or other component) may mate with the feature once the optical coupling device is aligned and secured (e.g., with epoxy) into place. The feature may also facilitate setting of rotation height.

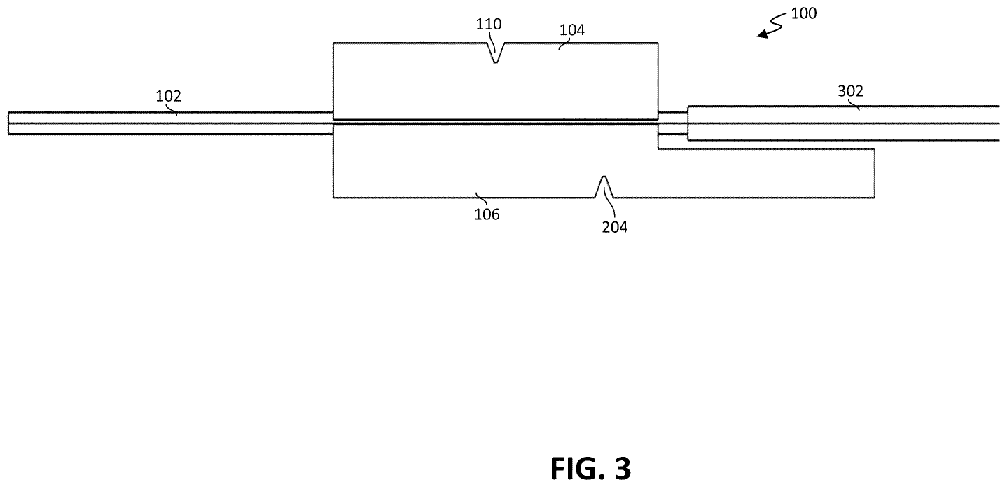

FIG. 3 illustrates a side view of the optical coupling device 100, in accordance with any of the embodiments disclosed herein. In this view, a coating 302 over a fiber 102 is shown. This view also depicts the shapes of the alignment features 110 and 204 in more detail.

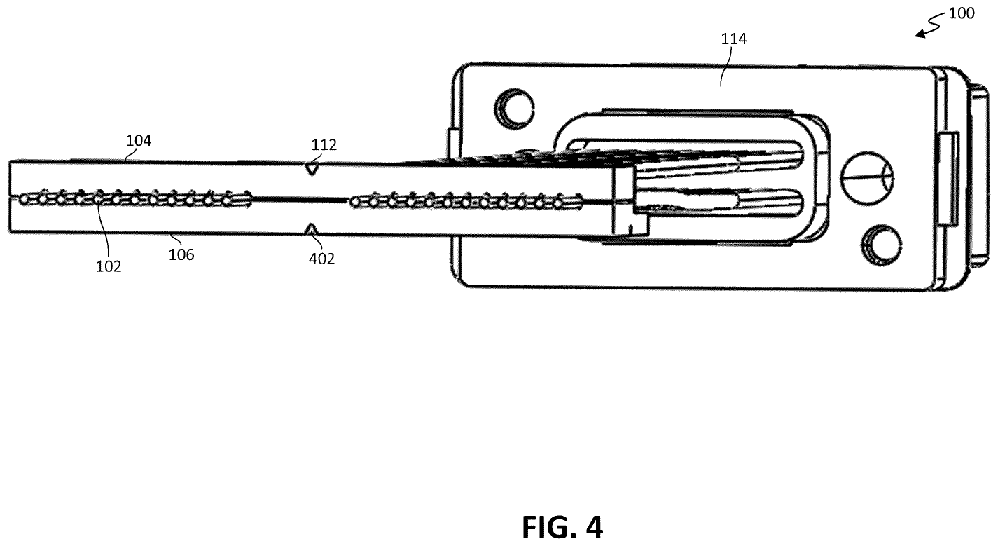

FIG. 4 illustrates another perspective view of the optical coupling device 100, in accordance with any of the embodiments disclosed herein. This view shows the fibers 102 secured between the upper block 104 and the lower block 106. This view also depicts an additional alignment feature 402 on the lower block 106. The alignment feature 402 is shown as a V-shaped recess formed on the bottom surface of the lower block 106. The alignment feature 402 may be parallel to the alignment feature 112 and the fibers 102. In some embodiments, the alignment feature 402 is centered between the fibers 102.

In various embodiments, the alignment features on the bottom surface of the at least one block may include any suitable characteristics described above with respect to alignment features on the top surface.

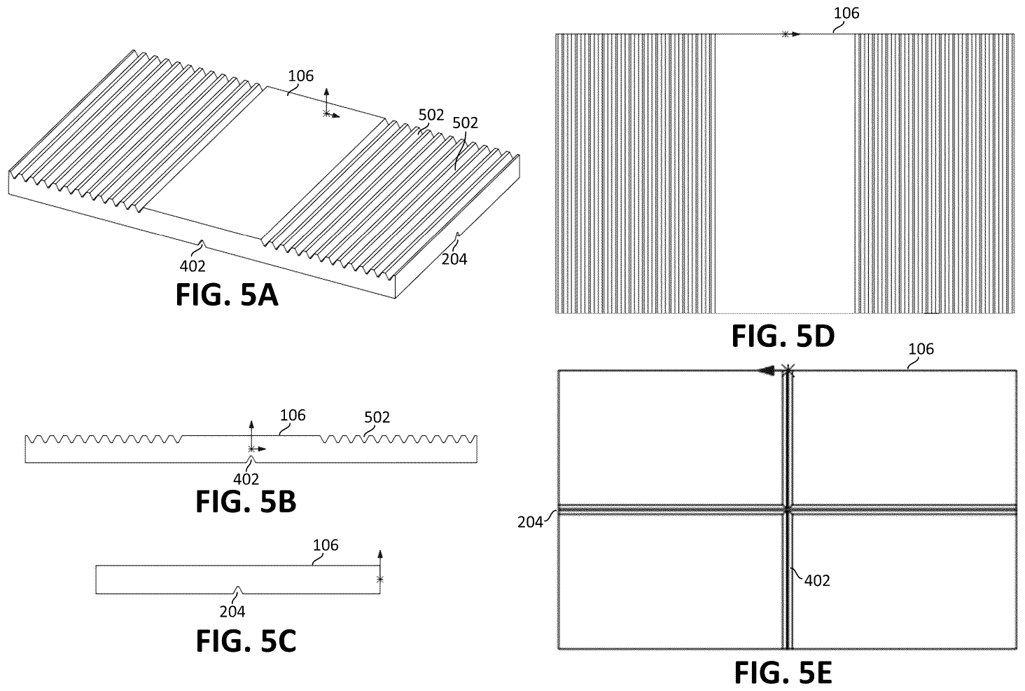

FIGS. 5A-5E illustrate views of a lower block 106 of an optical coupling device, in accordance with any of the embodiments disclosed herein. FIG. 5A illustrates a perspective view of the lower block 106, FIG. 5B illustrates a front view of the lower block 106, FIG. 5C illustrates a side view of the lower block 106, FIG. 5D illustrates a top view of the lower block 106, and FIG. 5E illustrates a bottom view of the lower block 106.

Various of these views illustrate V-shaped grooves 502 formed on the upper surface of the lower block 106. The fibers 102 may be placed within the grooves 502 during assembly of the FAU. In the embodiment depicted, two different sets of grooves 502 are separated by a flat portion of the surface of lower block 106, but other embodiments may have different physical arrangements.

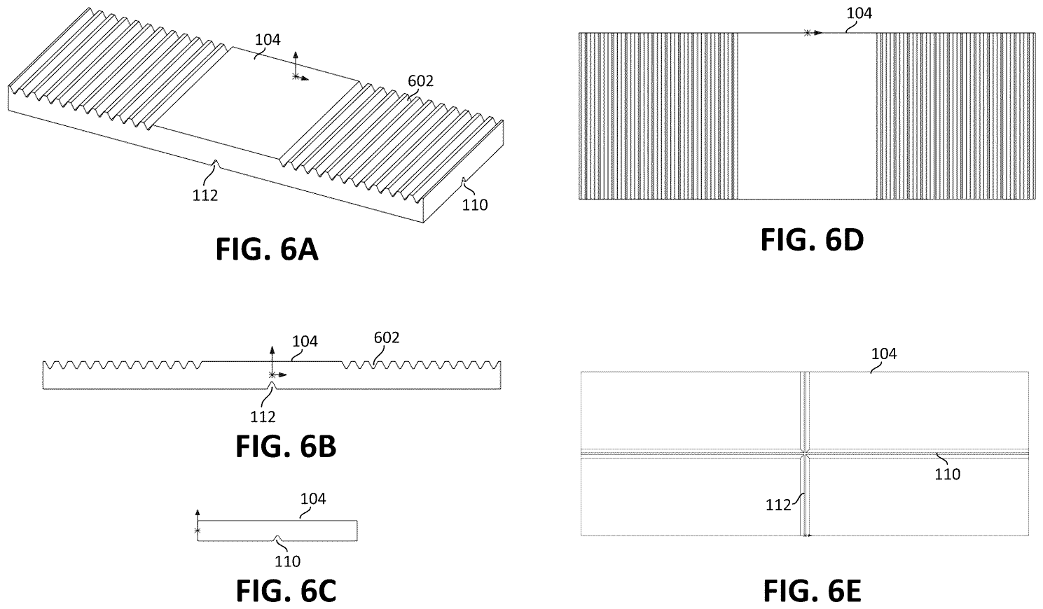

FIGS. 6A-6E illustrate views of an upper block 104 of an optical coupling device, in accordance with any of the embodiments disclosed herein. FIG. 6A illustrates a perspective view of the upper block 104 (where the upper block 104 is flipped over such that the lower surface is visible), FIG. 6B illustrates a front view of the upper block 104, FIG. 6C illustrates a side view of the upper block 104, FIG. 6D illustrates a bottom view of the upper block 104, and FIG. 6E illustrates a top view of the upper block 104.

Similar to the lower block 106, various of the views illustrate V-shaped grooves 602 formed on the lower surface of the upper block 104. The fibers 102 may be placed within the grooves 602 during assembly of the FAU. In the embodiment depicted, two different sets of grooves 602 are separated by a flat portion of the surface of upper block 104, but other embodiments may have different physical arrangements.

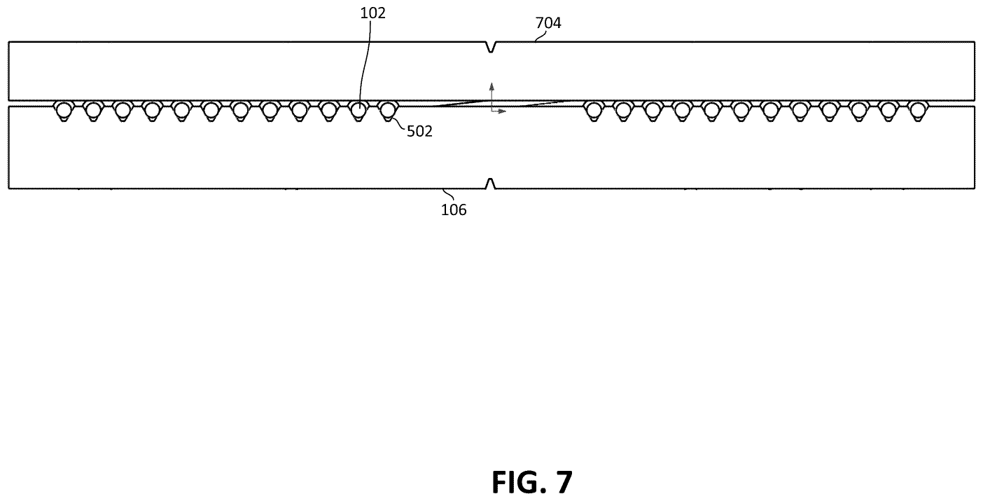

Although in the embodiment depicted, each block includes grooves for the fibers 102, in some embodiments, only one of the blocks includes grooves. In such embodiments, the respective surface of the other block may be flat. As an example, FIG. 7 illustrates a front view of an upper block 704 and a lower block 106 of an optical coupling device, in accordance with any of the embodiments disclosed herein. In this embodiment, the lower block 106 includes grooves 502 into which fibers 102 are placed. The lower surface of the upper block 704 is flat and the fibers 102 are placed in between the lower surface of the upper block 704 and the upper surface of the lower block 106.

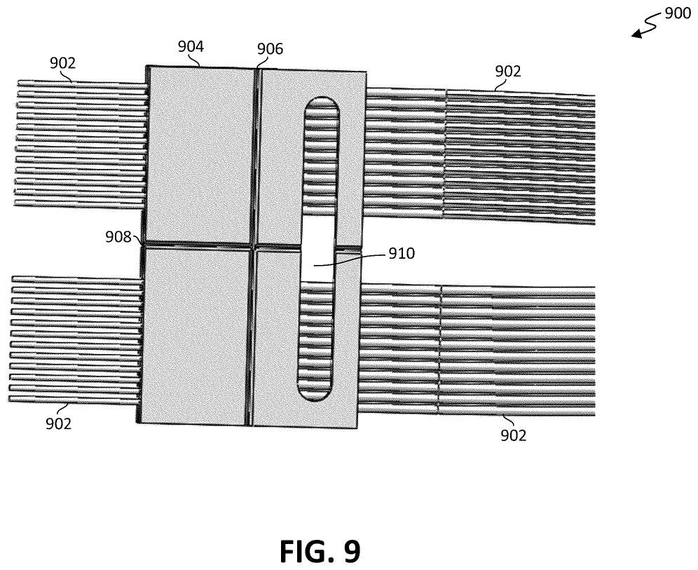

FIG. 9 illustrates a bottom view of an optical coupling device 900 with a lower block 904 comprising a slot 910, in accordance with any of the embodiments disclosed herein. In other embodiments, the lower block 904 may include any suitable number of slots. The lower block 904 may have any suitable characteristics of lower block 106. In the depicted embodiment, the lower block 904 comprises alignment features 906 and 908. The device 900 also includes fibers 902. Although not shown, the fibers 902 may also be coupled to a connector (e.g., an MT ferrule).

In some embodiments, the slot 910 may be used during coupling of the device 900 to a PIC. For example, adhesive or solder may be used to couple the lower block 904 to a package substrate on which the PIC is coupled and/or an integrated heat spreader (e.g., which may be attached to the PIC). The slot 910 may provide access to the adhesive or solder (e.g., for UV curing of the adhesive or application of an infrared laser to melt the solder).

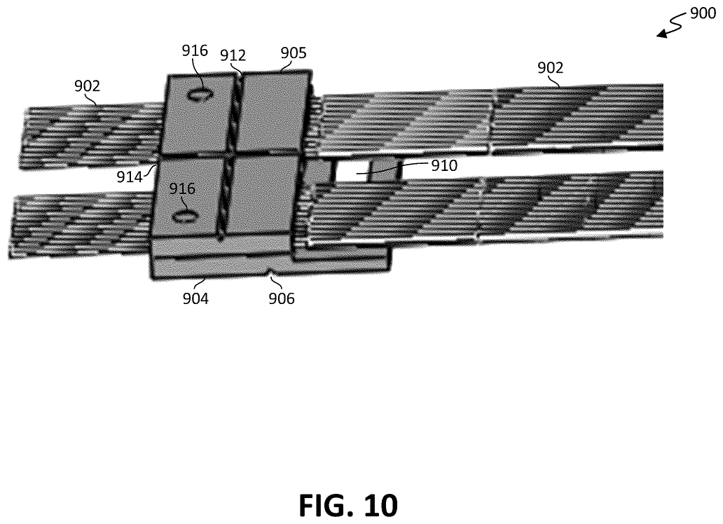

FIG. 10 illustrates a top view of the optical coupling device 900, in accordance with any of the embodiments disclosed herein. In this FIG., fibers 902 are coupled between upper block 905 and lower block 904. Upper block 905 may have any suitable characteristics of upper block 104. For example, the upper block includes alignment features 912 and 914 as well as alignment features 916.

Although the preceding FIGS. depict alignment features on both the upper blocks and lower blocks, in other embodiments, one or more alignment features may only be present on one of the upper block or lower block. Other embodiments also contemplate any suitable number of alignment features on the upper block and/or lower block. Furthermore, if an optical coupling device includes a single block (e.g., with fibers through the middle of the block), any suitable number of alignment features may be present on the upper surface and/or lower surface of the block.

Although the preceding FIGS. depict devices with two sets of twelve fibers that are separated by a portion that does not include fibers, other devices consistent with embodiments of the disclosure may include any suitable number of fibers (e.g., eight, ten, twelve, sixteen, twenty, twenty four, etc.) and any suitable number of sets (for example a single set, two sets, four sets, etc.).

Although the alignment features are shown as being formed on a surface (e.g., top or bottom) of a block by removing material of the block (e.g., by sawing, grinding, or lasing), in some embodiments, the alignment features may be located within a block. For example, a laser may be applied to generate alignment features (e.g., fiducials) inside of a block (e.g., using three dimensional crystal engraving). In other examples, the alignment features may be written as fiducials onto a surface of the block. In some such embodiments where the alignment features are fiducials, computing vision may be used to align the pick head with the block based on the alignment features.

Although the preceding illustrations depict an optical coupling device with fibers extending from an end of the upper and lower blocks (e.g., an FAU), in other embodiments, the optical coupling device may comprise an optical coupler with the alignment features described herein. Thus, references herein to optical fibers may also be applicable to other optical channels. An optical coupler may include waveguides (e.g., formed within one or more glass pieces or other material) to align at a first end with waveguides of the PIC die and at a second end with optical channels (e.g., waveguides or fibers) of another optical device. For example, the second end may interface with a ferrule of the other optical device or waveguides of the other optical device. Other suitable arrangements are contemplated herein for the optical coupling device.

The devices with the alignment features may be formed in any suitable manner and/or sequence. For example, the alignment features may be formed on the lower and/or upper block during wafer level processing of the blocks (where multiple blocks are formed in the same process on the same wafer). Fibers may be cut to length and a portion of the coating on the fibers may be stripped off. The fibers may then be placed in between the lower and upper block and the lower and upper block may be secured together (e.g., by applying an adhesive and applying UV light to the adhesive). The fiber tips extending from the blocks may then be cut and polished or ground (e.g., perpendicular to the fiber direction) based on one or more of the alignment features to achieve tip lengths within a tolerance. The fibers may also be routed into the connector (e.g., MT ferrule) and the connector may be polished.

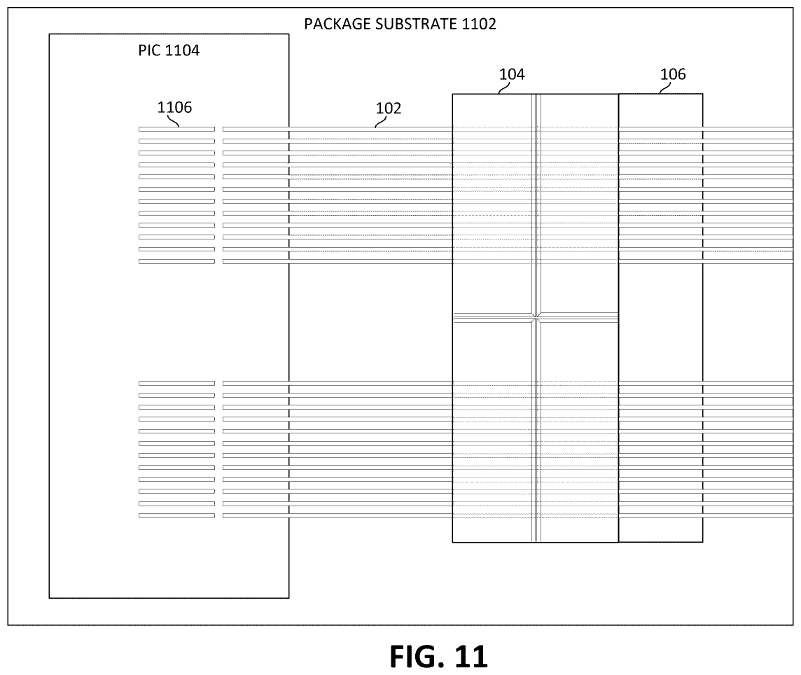

FIG. 11 illustrates a top view of an optical coupling device aligned with a PIC 1104, in accordance with any of the embodiments disclosed herein. The PIC 1104 is on a package substrate 1102. The PIC includes a plurality of waveguides 1106 oriented in the same direction as the fibers 102. The device 100 is positioned such that the fibers 102 align sufficiently with the waveguides 1106. In various embodiments, the PIC 1104 may include grooves (e.g., V-grooves) in line with the waveguides 1106 into which the fibers 102 are placed. In some instances, the fibers 102 may be attached to the PIC 1104 with an adhesive, such as an index-matching epoxy (IME) and/or the blocks 104, 106 may be attached to the package substrate (e.g., via solder or adhesive).

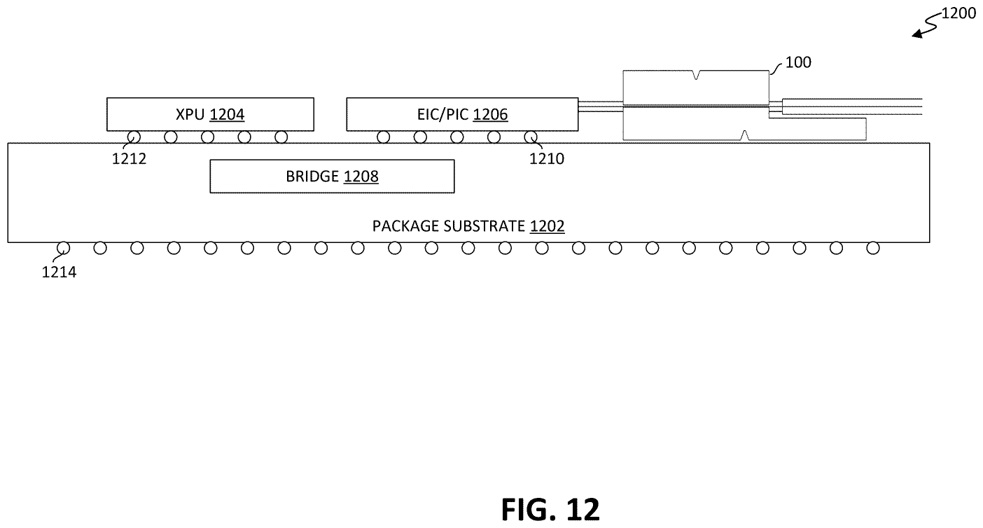

FIG. 12 illustrates an example embodiment of an optical package 1200 in accordance with certain embodiments. In some embodiments, optical package 1200 may include the PIC and/or optical coupling device designs described throughout this disclosure.

In the illustrated embodiment, the optical package 1200 includes an XPU 1204, an integrated electronic integrated circuit (EIC) and PIC 1206, an optical coupling device 100 on a package substrate 1202. The optical coupling device 100 is attached to the side/edge of the EIC/PIC 1206. In other embodiments, the EIC and the PIC may be on separate dies.

An EIC is used to control a PIC and may include components such as drivers, transimpedance amplifiers (TIA), carrier phase recovery (CPR), clock/data recovery (CDR), serializer/deserializer, equalizer, sampler, and so forth.

The EIC/PIC 1206 is electrically coupled to the package substrate 1202 via conductive contacts 1210 (e.g., bumps/micro-bumps), and the EIC/PIC 1206 is further electrically coupled to the XPU 1204 via bridge 1208 embedded in the package substrate 1202.

A PIC, sometimes referred to as an integrated optical circuit, is an integrated circuit device that incorporates photonic components to create a functional circuit. For example, a PIC may be capable of detecting, generating, transporting, and/or processing light. Unlike electronic integrated circuits (EICs) that rely on electrons, PICs may utilize particles of light called photons. A PIC may enable the manipulation of information signals carried by optical wavelengths, typically within the visible spectrum or near infrared range.

A PIC may be used to send and/or receive optical signals via optical channels (e.g., a medium through which optical signals are transmitted). For example, the PIC of EIC/PIC 1206 may be used to send and/or receive optical signals via fiber arrays of device 100. In various embodiments, a PIC may send and/or receive optical signals on behalf of another component (e.g., of the same package), such as a processing unit (e.g., an XPU 1204 as described below), network interface controller (NIC), storage, memory, I/O device, or other integrated circuit.

A PIC may include components and circuitry for sending and receiving optical signals, such as one or more electromagnetic radiation sources (e.g., laser diodes (LD)/modulators (LD-MOD), oscillators, light emitting diodes (LEDs), etc.), e.g., for transmitting optical signals; photodiodes (PD), e.g., for receiving optical signals; other optical elements (e.g., polarizers, phase shifters, filters, multiplexers, attenuators, waveguides, optical couplers, collimation/refocusing lenses, reflection mirrors, or amplifiers); active elements (e.g., transistors); passive elements (e.g., resistors, capacitors, or inductors); or other suitable components. In various embodiments, the components of the PIC may be fabricated using any suitable methods, such as semiconductor photolithographic and deposition methods.

A PIC may be controlled by an associated EIC which may be electrically coupled to the PIC. For example, a PIC may be electrically coupled to a surface of an EIC via conductive contacts (e.g., bumps/micro-bumps) of the PIC when the PIC and the EIC are on separate dies.

A PIC may also include an interface for coupling to optical channels of the device 100. The interface may comprise any suitable structure for coupling optical channels of the PIC to optical channels (e.g., fibers, waveguides) of the device 100. In some embodiments, the interface may include mating and/or alignment features to facilitate mating with the requisite degree of alignment to cause waveguides in a PIC to be precisely aligned with optical channels of the device.

A waveguide may guide optical signals. A waveguide may also perform any of coupling, switching, splitting, multiplexing, or demultiplexing optical signals. In some instances, a waveguide may include any component configured to feed, or launch, an electromagnetic signal into a medium of propagation such as an optical fiber. A waveguide may be formed in any suitable manner, such as by lithography or laser scribing. In some embodiments, a technique known as direct laser writing (DLW) may be used to generate waveguides with three dimensional (3D) structures (e.g., within a glass substrate). In some embodiments, the waveguides in a PIC are aligned along an optical axis of the PIC.

The device 100 may be used to optically couple, or route optical signals (e.g., light) between, the PIC and another component (e.g., coupled to a ferrule or other connector of the device 100), such as other computing components that are part of the same device or system as optical package 1200 (e.g., processors, XPUs, network interface controllers (NICs), storage, memory, I/O devices, other integrated circuits), an external device or system, a switch, another optical connector, a fiber cable, and so forth.

The XPU 1204 is attached to the top surface of the package substrate 1202. Moreover, the XPU 1204 is electrically coupled to the package substrate 1202 via conductive contacts 1212 (e.g., bumps/micro-bumps), which serve as the first level interconnect (FLI) for the XPU 1204. The XPU 1204 is also electrically coupled to the EIC/PIC 1206 via bridge 1208 embedded in the package substrate 1202 (e.g., embedded multi-die interconnect bridges (EMIB)). In this manner, the XPU 1204 can use the PIC of the EIC/PIC 1206 to communicate over the device 100.

The XPU 1204 may include any type or combination of integrated circuitry that uses the device 100 for optical communication. For example, the XPU 1204 may include any type or combination of processing units or other computing components, including, but not limited to, microcontrollers, microprocessors, processor cores, central processing units (CPUs), graphics processing units (GPUs), vision processing units (VPUs), tensor processing units (TPUs), application-specific integrated circuits (ASICs), field-programmable gate arrays (FPGAs), input/output (I/O) controllers and devices, switches, network interface controllers (NICs), persistent storage devices, and memory.

The package substrate 1202 includes conductive contacts 1214 (e.g., balls, pads) on the bottom surface, which serve as the second level interconnect (SLI) to a next-level component, such as a printed circuit board (e.g., a motherboard) and/or another integrated circuit package (not shown). The package substrate 1202 also includes conductive traces (not shown) patterned in the substrate to provide power and input/output (I/O) to the respective components in package 1200 (e.g., XPU 1204, EIC/PIC 1206).

In some embodiments, the optical package 1200 may be part of an electronic device or system, such as a mobile device, a wearable device, a computer, a server, a video playback device, a video game console, a display device, a camera, or an appliance. For example, the optical package 1200 and various other electronic components may be electrically coupled to a circuit board within the electronic device.

It should be appreciated that optical package 1200 is merely presented as an example. In other embodiments, certain components may be omitted, added, rearranged, modified, or combined. For example, embodiments may include any number, combination, or arrangement of PICs and EICs (e.g., for higher bandwidth and/or redundancy), optical coupler devices, fibers, waveguides, bridges, XPUs or other computing components, substrates, surface cavities in the substrate, conductive contacts, conductive traces, vias, integrated circuit packages, and so forth.

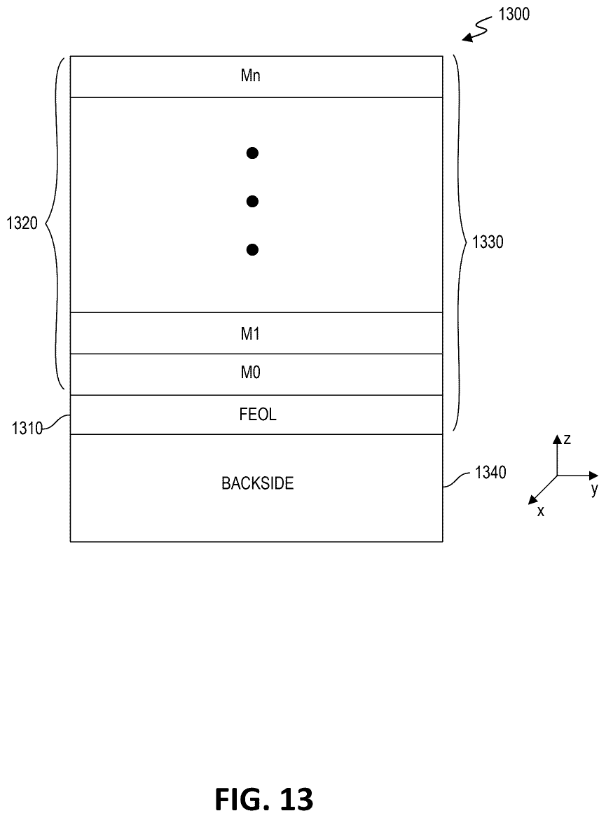

FIG. 13 provides a schematic illustration of a cross-sectional view of an example integrated circuit device (e.g., a die) 1300. The IC device 1300 may include transistors as well as other circuit elements (e.g., resistors, diodes, capacitors, inductors, etc.). In some instances, the IC device 2400 may comprise a PIC, EIC, XPU, or other component described herein.

As shown in FIG. 13, the IC device 1300 may include a front side 1330 comprising a front-end-of-line (FEOL) 1310 that includes various logic layers, circuits, and devices to drive and control a logic IC. These circuits and devices may be configured for any number of functions, such as logic or compute transistors, input/output (I/O) transistors, access or switching transistors, and/or radio frequency (RF) transistors, to name a few examples. According to some embodiments, in addition to these devices and circuits, FEOL 1310 may include, for example, one or more other layers or structures associated with the semiconductor devices and circuits. For example, the FEOL can also include a substrate and one or more dielectric layers that surround active and/or conductive portions of the devices and circuits. The FEOL may also include one or more conductive contacts that provide electrical contact to transistor elements such as gate structures, drain regions, or source regions. The FEOL may also include local interconnect (e.g., vias or lines) that connect contacts to interconnect features within a back-end-of-line (BEOL) 1320.

The front side 1330 of the IC device 1300 also includes a BEOL 1320 including various metal interconnect layers (e.g., metal 0 through metal n, where n is any suitable integer). Various metal layers of the BEOL 1320 may be used to interconnect the various inputs and outputs of the FEOL 1310.

Generally speaking, each of the metal layers of the BEOL 1320, e.g., each of the layers M0-Mn shown in FIG. 13, may include a via portion and a trench/interconnect portion. Typically, the trench portion of a metal layer is above the via portion, but, in other embodiments, a trench portion may be provided below a via portion of any given metal layer of the BEOL 1320. The trench portion of a metal layer may be configured for transferring signals and power along metal lines (also sometimes referred to as “trenches”) extending in the x-y plane (e.g., in the x or y directions), while the via portion of a metal layer may be configured for transferring signals and power through metal vias extending in the z-direction, e.g., to any of the adjacent metal layers above or below. Accordingly, vias connect metal structures (e.g., metal lines or vias) from one metal layer to metal structures of an adjacent metal layer. While referred to as “metal” layers, various layers of the BEOL 1320, e.g., layers M0-Mn shown in FIG. 13, may include certain patterns of conductive metals, e.g., copper (Cu) or aluminum (Al), or metal alloys, or more generally, patterns of an electrically conductive material (e.g., including carbon based materials), formed in an insulating medium such as an interlayer dielectric (ILD). The insulating medium may include any suitable ILD materials such as silicon oxide, silicon nitride, aluminum oxide, and/or silicon oxynitride. In various embodiments, any one or more of these layers may additionally include active devices (e.g., transistors, diodes) and/or passive devices (e.g., capacitors, resistors, inductors).

The IC device 1300 may also include a backside 1340. For example, the backside 1340 may formed on the opposite side of a wafer from the front side 1330. In various embodiments, the backside 1340 may include any suitable elements to assist operation of the IC device 1300. For example, the backside 1340 may include various metal layers to deliver power to logic of the FEOL 1310.

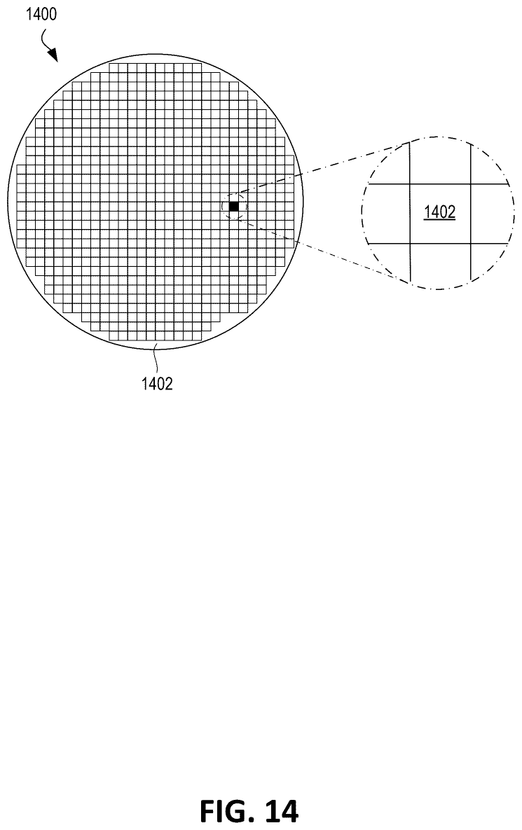

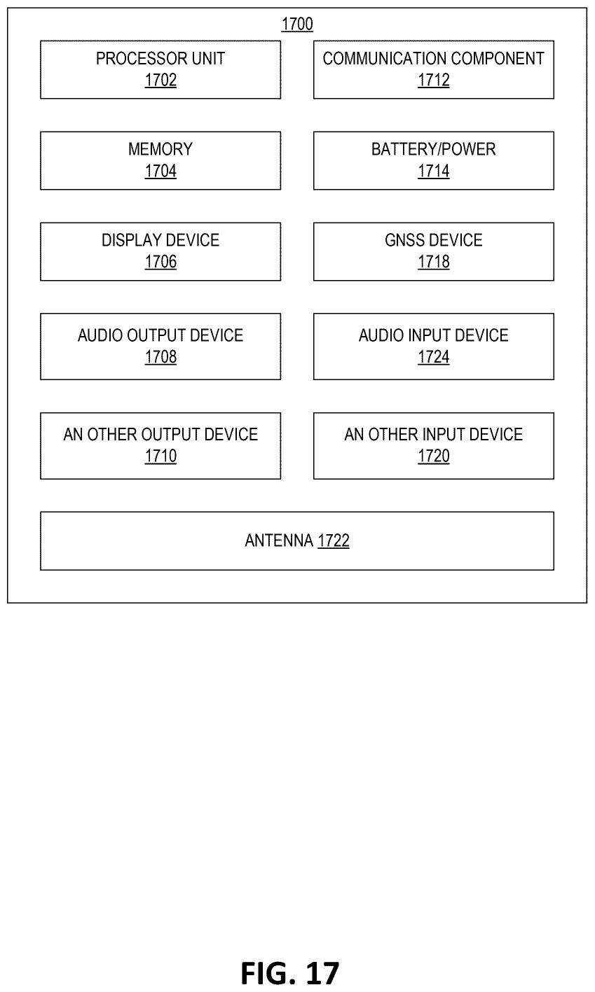

FIG. 14 is a top view of a wafer 1400 and dies 1402, wherein individual dies may include PICs, EICs, XPUs, and/or other components as disclosed herein. The wafer 1400 may be composed of semiconductor material and may include one or more dies 1402 having integrated circuit structures formed on a surface of the wafer 1400. The individual dies 1402 may be a repeating unit of an integrated circuit product that includes any suitable integrated circuit. After the fabrication of the semiconductor product is complete, the wafer 1400 may undergo a singulation process in which the dies 1402 are separated from one another to provide discrete “chips” of the integrated circuit product. The die 1402 may include one or more transistors, supporting circuitry to route electrical signals to the transistors, passive components (e.g., signal traces, resistors, capacitors, or inductors), and/or any other integrated circuit components. In some embodiments, the wafer 1400 or the die 1402 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1402. For example, a memory array formed by multiple memory devices may be formed on a same die 1402 as a processor unit (e.g., the processor unit 1702 of FIG. 17) or other logic that is configured to store information in the memory devices or execute instructions stored in the memory array. In some embodiments, various ones of the microelectronic assemblies disclosed herein may be manufactured using a die-to-wafer assembly technique in which some dies are attached to a wafer 1400 that include other dies, and the wafer 1400 is subsequently singulated.

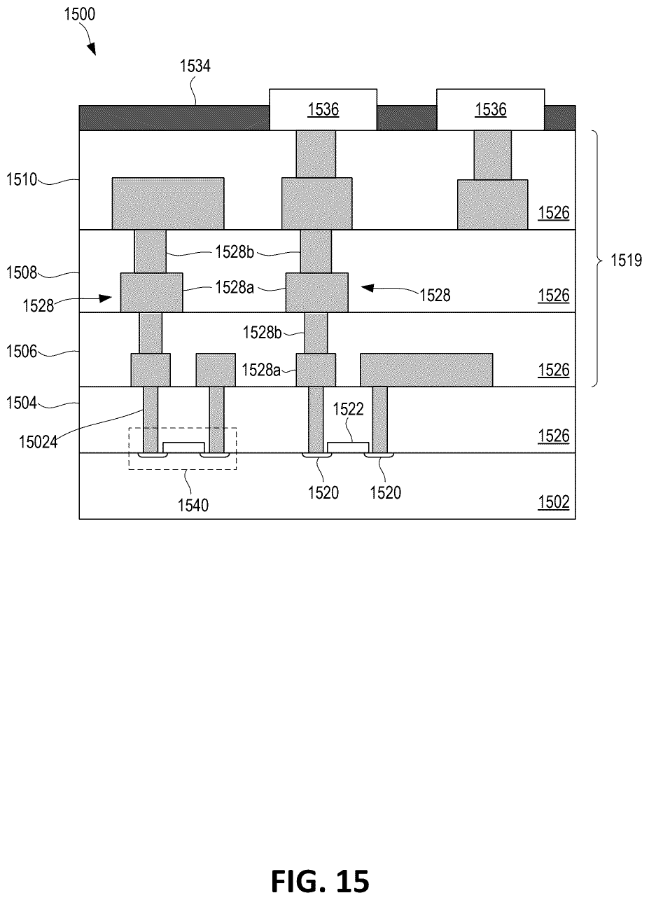

FIG. 15 is a cross-sectional side view of an integrated circuit device 1500 that may include PICs, EICs, XPUs, and/or other components as disclosed herein. One or more of the integrated circuit devices 1500 may be included in one or more dies 1402 (FIG. 14). The integrated circuit device 1500 may be formed on a die substrate 1502 (e.g., the wafer 1400 of FIG. 14) and may be included in a die (e.g., the die 1402 of FIG. 14). The die substrate 1502 may be a semiconductor substrate composed of semiconductor material systems including, for example, n-type or p-type materials systems (or a combination of both). The die substrate 1502 may include, for example, a crystalline substrate formed using a bulk silicon or a silicon-on-insulator (SOI) substructure. In some embodiments, the die substrate 1502 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 1502. Although a few examples of materials from which the die substrate 1502 may be formed are described here, any material that may serve as a foundation for an integrated circuit device 1500 may be used. The die substrate 1502 may be part of a singulated die (e.g., the dies 1402 of FIG. 14) or a wafer (e.g., the wafer 1400 of FIG. 14).

The integrated circuit device 1500 may include one or more device layers 1504 disposed on the die substrate 1502. The device layer 1504 may include features of one or more transistors 1540 (e.g., metal oxide semiconductor field-effect transistors (MOSFETs)) formed on the die substrate 1502. The transistors 1540 may include, for example, one or more source and/or drain (S/D) regions 1520, a gate 1522 to control current flow between the S/D regions 1520, and one or more S/D contacts 1524 to route electrical signals to/from the S/D regions 1520. The transistors 1540 may include additional features not depicted for the sake of clarity, such as device isolation regions, gate contacts, and the like. The transistors 1540 are not limited to the type and configuration depicted in FIG. 15 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

A transistor 1540 may include a gate 1522 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1540 is to be a p-type metal oxide semiconductor (PMOS) or an n-type metal oxide semiconductor (NMOS) transistor. In some implementations, the gate electrode may consist of or comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1540 along the source-channel-drain direction, the gate electrode may consist of or comprise a U-shaped structure that includes a bottom portion substantially parallel to the surface of the die substrate 1502 and two sidewall portions that are substantially perpendicular to the top surface of the die substrate 1502. In other embodiments, at least one of the metal layers that form the gate electrode may simply be a planar layer that is substantially parallel to the top surface of the die substrate 1502 and does not include sidewall portions substantially perpendicular to the top surface of the die substrate 1502. In other embodiments, the gate electrode may consist of or comprise a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1520 may be formed within the die substrate 1502 adjacent to the gate 1522 of individual transistors 1540. The S/D regions 1520 may be formed using an implantation/diffusion process or an etching/deposition process, for example. In the former process, dopants such as boron, aluminum, antimony, phosphorous, or arsenic may be ion-implanted into the die substrate 1502 to form the S/D regions 1520. An annealing process that activates the dopants and causes them to diffuse farther into the die substrate 1502 may follow the ion-implantation process. In the latter process, the die substrate 1502 may first be etched to form recesses at the locations of the S/D regions 1520. An epitaxial deposition process may then be carried out to fill the recesses with material that is used to fabricate the S/D regions 1520. In some implementations, the S/D regions 1520 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1520 may be formed using one or more alternate semiconductor materials such as germanium or a group III-V material or alloy. In further embodiments, one or more layers of metal and/or metal alloys may be used to form the S/D regions 1520.

Electrical signals, such as power and/or input/output (I/O) signals, may be routed to and/or from the devices (e.g., transistors 1540) of the device layer 1504 through one or more interconnect layers disposed on the device layer 1504 (illustrated in FIG. 15 as interconnect layers 1506-1510). For example, electrically conductive features of the device layer 1504 (e.g., the gate 1522 and the S/D contacts 1524) may be electrically coupled with the interconnect structures 1528 of the interconnect layers 1506-1510. The one or more interconnect layers 1506-1510 may form a metallization stack (also referred to as an “ILD stack”) 1519 of the integrated circuit device 1500.

The interconnect structures 1528 (e.g., lines) may be arranged within the interconnect layers 1506-1510 to route electrical signals according to a wide variety of designs; in particular, the arrangement is not limited to the particular configuration of interconnect structures 1528 depicted in FIG. 15. Although a particular number of interconnect layers 1506-1510 is depicted in FIG. 15, embodiments of the present disclosure include integrated circuit devices having more or fewer interconnect layers than depicted.

In some embodiments, the interconnect structures 1528 may include lines 1528a and/or vias 1528b filled with an electrically conductive material such as a metal. The lines 1528a may be arranged to route electrical signals in a direction of a plane that is substantially parallel with a surface of the die substrate 1502 upon which the device layer 1504 is formed. For example, the lines 1528a may route electrical signals in a direction in and out of the page and/or in a direction across the page. The vias 1528b may be arranged to route electrical signals in a direction of a plane that is substantially perpendicular to the surface of the die substrate 1502 upon which the device layer 1504 is formed. In some embodiments, the vias 1528b may electrically couple lines 1528a of different interconnect layers 1506-1510 together.

The interconnect layers 1506-1510 may include a dielectric material 1526 disposed between the interconnect structures 1528, as shown in FIG. 15. In some embodiments, dielectric material 1526 disposed between the interconnect structures 1528 in different ones of the interconnect layers 1506-1510 may have different compositions; in other embodiments, the composition of the dielectric material 1526 between different interconnect layers 1506-1510 may be the same. The device layer 1504 may include a dielectric material 1526 disposed between the transistors 1540 and a bottom layer of the metallization stack as well. The dielectric material 1526 included in the device layer 1504 may have a different composition than the dielectric material 1526 included in the interconnect layers 1506-1510; in other embodiments, the composition of the dielectric material 1526 in the device layer 1504 may be the same as a dielectric material 1526 included in any one of the interconnect layers 1506-1510.

A first interconnect layer 1506 (referred to as Metal 1 or “M1”) may be formed directly on the device layer 1504. In some embodiments, the first interconnect layer 1506 may include lines 1528a and/or vias 1528b, as shown. The lines 1528a of the first interconnect layer 1506 may be coupled with contacts (e.g., the S/D contacts 1524) of the device layer 1504. The vias 1528b of the first interconnect layer 1506 may be coupled with the lines 1528a of a second interconnect layer 1508.

The second interconnect layer 1508 (referred to as Metal 2 or “M2”) may be formed directly on the first interconnect layer 1506. In some embodiments, the second interconnect layer 1508 may include via 1528b to couple the lines 1528 of the second interconnect layer 1508 with the lines 1528a of a third interconnect layer 1510. Although the lines 1528a and the vias 1528b are structurally delineated with a line within individual interconnect layers for the sake of clarity, the lines 1528a and the vias 1528b may be structurally and/or materially contiguous (e.g., simultaneously filled during a dual-damascene process) in some embodiments.

The third interconnect layer 1510 (referred to as Metal 3 or “M3”) (and additional interconnect layers, as desired) may be formed in succession on the second interconnect layer 1508 according to similar techniques and configurations described in connection with the second interconnect layer 1508 or the first interconnect layer 1506. In some embodiments, the interconnect layers that are “higher up” in the metallization stack 1519 in the integrated circuit device 1500 (i.e., farther away from the device layer 1504) may be thicker that the interconnect layers that are lower in the metallization stack 1519, with lines 1528a and vias 1528b in the higher interconnect layers being thicker than those in the lower interconnect layers.

The integrated circuit device 1500 may include a solder resist material 1534 (e.g., polyimide or similar material) and one or more conductive contacts 1536 formed on the interconnect layers 1506-1510. In FIG. 15, the conductive contacts 1536 are illustrated as taking the form of bond pads. The conductive contacts 1536 may be electrically coupled with the interconnect structures 1528 and configured to route the electrical signals of the transistor(s) 1540 to external devices. For example, solder bonds may be formed on the one or more conductive contacts 1536 to mechanically and/or electrically couple an integrated circuit die including the integrated circuit device 1500 with another component (e.g., a printed circuit board). The integrated circuit device 1500 may include additional or alternate structures to route the electrical signals from the interconnect layers 1506-1510; for example, the conductive contacts 1536 may include other analogous features (e.g., posts) that route the electrical signals to external components.

In some embodiments in which the integrated circuit device 1500 is a double-sided die, the integrated circuit device 1500 may include another metallization stack (not shown) on the opposite side of the device layer(s) 1504. This metallization stack may include multiple interconnect layers as discussed above with reference to the interconnect layers 1506-1510, to provide conductive pathways (e.g., including conductive lines and vias) between the device layer(s) 1504 and additional conductive contacts (not shown) on the opposite side of the integrated circuit device 1500 from the conductive contacts 1536.

In other embodiments in which the integrated circuit device 1500 is a double-sided die, the integrated circuit device 1500 may include one or more through silicon vias (TSVs) through the die substrate 1502; these TSVs may make contact with the device layer(s) 1504, and may provide conductive pathways between the device layer(s) 1504 and additional conductive contacts (not shown) on the opposite side of the integrated circuit device 1500 from the conductive contacts 1536. In some embodiments, TSVs extending through the substrate can be used for routing power and ground signals from conductive contacts on the opposite side of the integrated circuit device 1500 from the conductive contacts 1536 to the transistors 1540 and any other components integrated into the integrated circuit device (e.g., die) 1500, and the metallization stack 1519 can be used to route I/O signals from the conductive contacts 1536 to transistors 1540 and any other components integrated into the integrated circuit device (e.g., die) 1500.

Multiple integrated circuit devices 1500 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

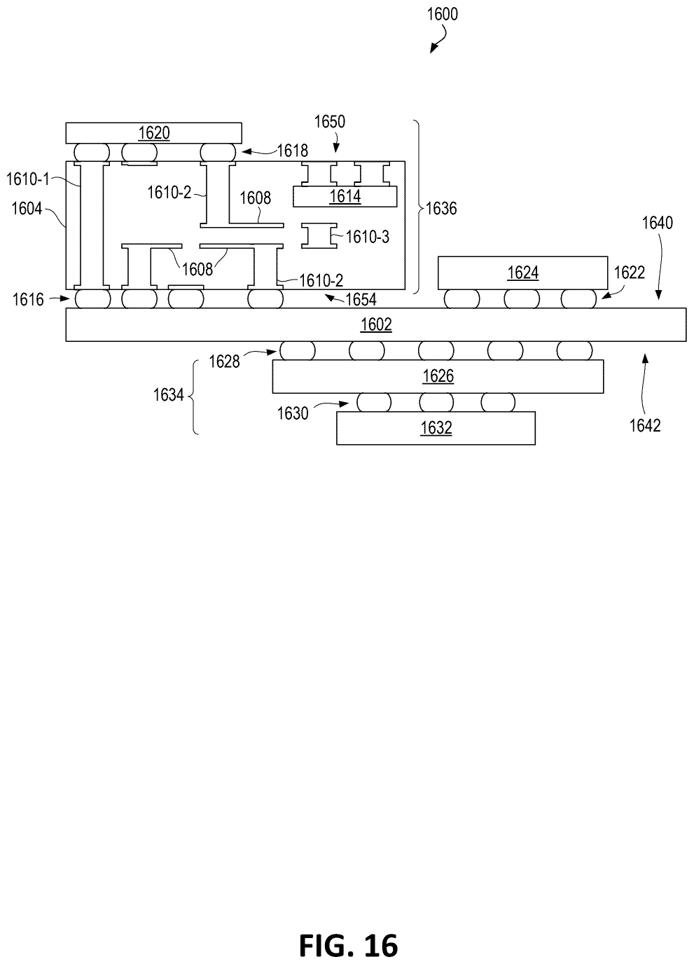

FIG. 16 is a cross-sectional side view of an integrated circuit device assembly 1600 that may include optical coupling devices, PICs, EICs, XPUs, and/or other components as disclosed herein. In some embodiments, the integrated circuit device assembly 1600 may be a microelectronic assembly. The integrated circuit device assembly 1600 includes a number of components disposed on a circuit board 1602 (which may be a motherboard, system board, mainboard, etc.). The integrated circuit device assembly 1600 includes components disposed on a first face 1640 of the circuit board 1602 and an opposing second face 1642 of the circuit board 1602; generally, components may be disposed on one or both faces 1640 and 1642.

In some embodiments, the circuit board 1602 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1602. In other embodiments, the circuit board 1602 may be a non-PCB substrate. The integrated circuit device assembly 1600 illustrated in FIG. 16 includes a package-on-interposer structure 1636 coupled to the first face 1640 of the circuit board 1602 by coupling components 1616. The coupling components 1616 may electrically and mechanically couple the package-on-interposer structure 1636 to the circuit board 1602, and may include solder balls (as shown in FIG. 16), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1636 may include an integrated circuit component 1620 coupled to an interposer 1604 by coupling components 1618. The coupling components 1618 may take any suitable form for the application, such as the forms discussed above with reference to the coupling components 1616. Although a single integrated circuit component 1620 is shown in FIG. 16, multiple integrated circuit components may be coupled to the interposer 1604; indeed, additional interposers may be coupled to the interposer 1604. The interposer 1604 may provide an intervening substrate used to bridge the circuit board 1602 and the integrated circuit component 1620.

The integrated circuit component 1620 may be a packaged or unpackaged integrated circuit product that includes one or more integrated circuit dies (e.g., the die 1402 of FIG. 14, the integrated circuit device 1500 of FIG. 15) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1620, a single monolithic integrated circuit die comprises solder bumps attached to contacts on the die. The solder bumps allow the die to be directly attached to the interposer 1604. The integrated circuit component 1620 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1620 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1620 comprises multiple integrated circuit dies, the dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1620 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1604 may spread connections to a wider pitch or reroute a connection to a different connection. For example, the interposer 1604 may couple the integrated circuit component 1620 to a set of ball grid array (BGA) conductive contacts of the coupling components 1616 for coupling to the circuit board 1602. In the embodiment illustrated in FIG. 16, the integrated circuit component 1620 and the circuit board 1602 are attached to opposing sides of the interposer 1604; in other embodiments, the integrated circuit component 1620 and the circuit board 1602 may be attached to a same side of the interposer 1604. In some embodiments, three or more components may be interconnected by way of the interposer 1604.

In some embodiments, the interposer 1604 may be formed as a PCB, including multiple metal layers separated from one another by layers of dielectric material and interconnected by electrically conductive vias. In some embodiments, the interposer 1604 may be formed of an epoxy resin, a fiberglass-reinforced epoxy resin, an epoxy resin with inorganic fillers, a ceramic material, or a polymer material such as polyimide. In some embodiments, the interposer 1604 may be formed of alternate rigid or flexible materials that may include the same materials described above for use in a semiconductor substrate, such as silicon, germanium, and other group III-V and group IV materials. The interposer 1604 may include metal interconnects 1608 and vias 1610, including but not limited to through hole vias 1610-1 (that extend from a first face 1650 of the interposer 1604 to a second face 1654 of the interposer 1604), blind vias 1610-2 (that extend from the first or second faces 1650 or 1654 of the interposer 1604 to an internal metal layer), and buried vias 1610-3 (that connect internal metal layers).

In some embodiments, the interposer 1604 can comprise a silicon interposer. Through silicon vias (TSV) extending through the silicon interposer can connect connections on a first face of a silicon interposer to an opposing second face of the silicon interposer. In some embodiments, an interposer 1604 comprising a silicon interposer can further comprise one or more routing layers to route connections on a first face of the interposer 1604 to an opposing second face of the interposer 1604.

The interposer 1604 may further include embedded devices 1614, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1604. The package-on-interposer structure 1636 may take the form of any of the package-on-interposer structures known in the art.

The integrated circuit device assembly 1600 may include an integrated circuit component 1624 coupled to the first face 1640 of the circuit board 1602 by coupling components 1622. The coupling components 1622 may take the form of any of the embodiments discussed above with reference to the coupling components 1616, and the integrated circuit component 1624 may take the form of any of the embodiments discussed above with reference to the integrated circuit component 1620.

The integrated circuit device assembly 1600 illustrated in FIG. 16 includes a package-on-package structure 1634 coupled to the second face 1642 of the circuit board 1602 by coupling components 1628. The package-on-package structure 1634 may include an integrated circuit component 1626 and an integrated circuit component 1632 coupled together by coupling components 1630 such that the integrated circuit component 1626 is disposed between the circuit board 1602 and the integrated circuit component 1632. The coupling components 1628 and 1630 may take the form of any of the embodiments of the coupling components 1616 discussed above, and the integrated circuit components 1626 and 1632 may take the form of any of the embodiments of the integrated circuit component 1620 discussed above. The package-on-package structure 1634 may be configured in accordance with any of the package-on-package structures known in the art.

FIG. 17 is a block diagram of an example electrical device 1700 that may include optical coupling devices, PICs, EICs, XPUs, and/or other components as disclosed herein. For example, any suitable components of the electrical device 1700 may include one or more of the integrated circuit device assemblies 1600, integrated circuit components 1620, integrated circuit devices 1500, integrated circuit dies 1402, or other components disclosed herein. A number of components are illustrated in FIG. 17 as included in the electrical device 1700, but any one or more of these components may be omitted or duplicated, as suitable for the application. In some embodiments, some or all of the components included in the electrical device 1700 may be attached to one or more motherboards mainboards, or system boards. In some embodiments, one or more of these components are fabricated onto a single system-on-a-chip (SoC) die.

Additionally, in various embodiments, the electrical device 1700 may not include one or more of the components illustrated in FIG. 17, but the electrical device 1700 may include interface circuitry for coupling to the one or more components. For example, the electrical device 1700 may not include a display device 1706, but may include display device interface circuitry (e.g., a connector and driver circuitry) to which a display device 1706 may be coupled. In another set of examples, the electrical device 1700 may not include an audio input device 1724 or an audio output device 1708, but may include audio input or output device interface circuitry (e.g., connectors and supporting circuitry) to which an audio input device 1724 or audio output device 1708 may be coupled.

The electrical device 1700 may include one or more processor units 1702 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1702 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1700 may include a memory 1704, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1704 may include memory that is located on the same integrated circuit die as the processor unit 1702. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1700 can comprise one or more processor units 1702 that are heterogeneous or asymmetric to another processor unit 1702 in the electrical device 1700. There can be a variety of differences between the processing units 1702 in a system in terms of a spectrum of metrics of merit including architectural, microarchitectural, thermal, power consumption characteristics, and the like. These differences can effectively manifest themselves as asymmetry and heterogeneity among the processor units 1702 in the electrical device 1700.

In some embodiments, the electrical device 1700 may include a communication component 1712 (e.g., one or more communication components). For example, the communication component 1712 can manage wireless communications for the transfer of data to and from the electrical device 1700. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1712 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1712 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1712 may operate in accordance with other wireless protocols in other embodiments. The electrical device 1700 may include an antenna 1722 to facilitate wireless communications and/or to receive other wireless communications (such as amplitude modulation (AM) or frequency modulation (FM) radio transmissions).

In some embodiments, the communication component 1712 may manage wired communications, such as electrical, optical, or any other suitable communication protocols (e.g., IEEE 802.3 Ethernet standards). As noted above, the communication component 1712 may include multiple communication components. For instance, a first communication component 1712 may be dedicated to shorter-range wireless communications such as Wi-Fi or Bluetooth, and a second communication component 1712 may be dedicated to longer-range wireless communications such as global positioning system (GPS), EDGE, GPRS, CDMA, WiMAX, LTE, EV-DO, or others. In some embodiments, a first communication component 1712 may be dedicated to wireless communications, and a second communication component 1712 may be dedicated to wired communications.

The electrical device 1700 may include battery/power circuitry 1714. The battery/power circuitry 1714 may include one or more energy storage devices (e.g., batteries or capacitors) and/or circuitry for coupling components of the electrical device 1700 to an energy source separate from the electrical device 1700 (e.g., AC line power).

The electrical device 1700 may include a display device 1706 (or corresponding interface circuitry, as discussed above). The display device 1706 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1700 may include an audio output device 1708 (or corresponding interface circuitry, as discussed above). The audio output device 1708 may include any embedded or wired or wirelessly connected external device that generates an audible indicator, such speakers, headsets, or earbuds.

The electrical device 1700 may include an audio input device 1724 (or corresponding interface circuitry, as discussed above). The audio input device 1724 may include any embedded or wired or wirelessly connected device that generates a signal representative of a sound, such as microphones, microphone arrays, or digital instruments (e.g., instruments having a musical instrument digital interface (MIDI) output). The electrical device 1700 may include a Global Navigation Satellite System (GNSS) device 1718 (or corresponding interface circuitry, as discussed above), such as a Global Positioning System (GPS) device. The GNSS device 1718 may be in communication with a satellite-based system and may determine a geolocation of the electrical device 1700 based on information received from one or more GNSS satellites, as known in the art.

The electrical device 1700 may include an other output device 1710 (or corresponding interface circuitry, as discussed above). Examples of the other output device 1710 may include an audio codec, a video codec, a printer, a wired or wireless transmitter for providing information to other devices, or an additional storage device.

The electrical device 1700 may include an other input device 1720 (or corresponding interface circuitry, as discussed above). Examples of the other input device 1720 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1700 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1700 may be any other electronic device that processes data. In some embodiments, the electrical device 1700 may comprise multiple discrete physical components. Given the range of devices that the electrical device 1700 can be manifested as in various embodiments, in some embodiments, the electrical device 1700 can be referred to as a computing device or a computing system.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

It will also be understood that, although the terms “first,” “second,” and so forth may be used herein to describe various elements, these elements should not be limited by these terms. These terms are only used to distinguish one element from another, and are not intended to imply that the objects so described must be in a given sequence, either temporally, spatially, in ranking or in any other manner. For example, a first contact could be termed a second contact, and, similarly, a second contact could be termed a first contact, without departing from the scope of the present example embodiments. The first contact and the second contact are both contacts, but they are not the same contact.

As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. For example, the phrase “A and/or B” means (A), (B), or (A and B), while the phrase “A, B, and/or C” means (A), (B), (C), (A and B), (A and C), (B and C), or (A, B, and C).

As used throughout this description, and in the claims, a list of items joined by the term “at least one of” or “one or more of” can mean any combination of the listed terms.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, the terms “comprising,” “including,” “having,” and the like, as used with respect to embodiments of the present disclosure, are synonymous.

The description may use the phrases “in an embodiment,” “according to some embodiments,” “in accordance with embodiments,” or “in embodiments,” which may each refer to one or more of the same or different embodiments.

As used herein, the term “module” refers to being part of, or including an ASIC, an electronic circuit, a system on a chip, a processor (shared, dedicated, or group), a solid state device, a memory (shared, dedicated, or group) that execute one or more software or firmware programs, a combinational logic circuit, and/or other suitable components that provide the described functionality.

As used herein, “electrically conductive” in some examples may refer to a property of a material having an electrical conductivity greater than or equal to 10⁷ Siemens per meter (S/m) at 20 degrees Celsius. Examples of such materials include Cu, Ag, Al, Au, W, Zn and Ni.

The term “signal” may refer to at least one current signal, voltage signal, magnetic signal, or data/clock signal.

Throughout the specification, and in the claims, the term “connected” means a direct connection, such as electrical, mechanical, or magnetic connection between the elements that are connected, without any intermediary devices. The term “coupled” means a direct or indirect connection, such as a direct electrical, mechanical, or magnetic connection between the elements that are connected or an indirect connection, through one or more passive or active intermediary devices.

The description may use perspective-based descriptions such as top/bottom, in/out, over/under, and the like. Such descriptions are merely used to facilitate the discussion and are not intended to restrict the application of embodiments described herein to any particular orientation.

The terms “over,” “under,” “between,” and “on” as used herein refer to a relative position of one component or material with respect to other components or materials where such physical relationships are noteworthy. For example, in the context of materials, one material or layer over or under another may be directly in contact or may have one or more intervening materials or layers. Moreover, one material between two materials or layers may be directly in contact with the two materials/layers or may have one or more intervening materials/layers. In contrast, a first material or layer “on” a second material or layer means that at least a part of the first material or layer is in direct physical contact with at least a part of that second material/layer. Similar distinctions are to be made in the context of component assemblies.

As used herein, “A is proximate to B” may mean that A is adjacent to B or A is otherwise near to B.

Unless otherwise specified in the specific context of use, the term “predominantly” means more than 50%, or more than half. For example, a composition that is predominantly a first constituent means more than half of the composition (e.g., by volume) is the first constituent (e.g., >50 at. %). The term “primarily” means the most, or greatest, part. For example, a composition that is primarily a first constituent means the composition has more of the first constituent (e.g., by volume) than any other constituent. A composition that is primarily first and second constituents means the composition has more of the first and second constituents than any other constituent. The term “substantially” means there is only incidental variation. For example, composition that is substantially a first constituent means the composition may further include <1% of any other constituent. A composition that is substantially first and second constituents means the composition may further include <1% of any constituent substituted for either the first or second constituent.

The terms “substantially,” “close,” “approximately,” “near,” and “about,” generally refer to being within +/−10% of a target value (unless specifically specified).

Unless otherwise specified in the explicit context of their use, the terms “substantially equal,” “about equal” or “approximately equal” mean that there is no more than incidental variation between two things so described. In the art, such variation is typically no more than +/−10% of a predetermined target value.

In the corresponding drawings of the embodiments, signals, currents, electrical biases, or magnetic or electrical polarities may be represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, polarity, current, voltage, etc., as dictated by design needs or preferences, may actually comprise one or more signals that may travel in either direction and may be implemented with any suitable type of signal scheme.

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

Although the figures may illustrate embodiments where structures are substantially aligned to Cartesian axes (e.g., device structures having substantially vertical sidewalls), positive and negative (re-entrant) sloped feature sidewalls often occur in practice. For example, manufacturing non-idealities may cause one or more structural features to have sloped sidewalls. Thus, attributes illustrated are idealized merely for the sake of clearly describing salient features. It is to be understood that schematic illustrations may not reflect real-life process limitations which may cause the features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of device fabrication.

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes an apparatus comprising at least one block comprising glass; and a plurality of optical channels, wherein the optical channels are encased within the at least one block along a portion of a length of the plurality of optical channels, the plurality of optical channels comprising first ends connected to an optical connector and second ends extending from the at least one block; wherein the at least one block comprises at least one feature to provide a reference point for alignment of the plurality of optical channels with optical channels of an integrated circuit die.

Example 2 includes the subject matter of Example 1, and wherein the at least one feature comprises a kinematic feature on a surface of the at least one block.

Example 3 includes the subject matter of any of Examples 1 and 2, and wherein the at least one feature comprises a fiducial.

Example 4 includes the subject matter of any of Examples 1-3, and wherein a feature of the at least one feature comprises a groove in a surface of the at least one block.

Example 5 includes the subject matter of any of Examples 1-4, and wherein a feature of the at least one feature is substantially parallel to the plurality of optical channels.

Example 6 includes the subject matter of any of Examples 1-5, and wherein a feature of the at least one feature is substantially perpendicular to the plurality of optical channels.

Example 7 includes the subject matter of any of Examples 1-6, and wherein a feature of the at least one feature extends from one side of the at least one block to an opposite side of the at least one block on a surface of the at least one block.

Example 8 includes the subject matter of any of Examples 1-7, and wherein the at least one feature comprises a first feature substantially parallel to the plurality of optical channels and a second feature substantially perpendicular to the plurality of optical channels, wherein the first feature and second feature intersect.

Example 9 includes the subject matter of any of Examples 1-8, and wherein the at least one feature comprises at least one first feature on a top surface of the at least one block and at least one second feature on a bottom surface of the at least one block.

Example 10 includes the subject matter of any of Examples 1-9, and further including the integrated circuit die.

Example 11 includes the subject matter of any of Examples 1-10, and further including a processor coupled to the package substrate and the integrated circuit die.

Example 12 includes the subject matter of any of Examples 1-11, and further including a printed circuit board coupled to the package substrate.

Example 13 includes the subject matter of any of Examples 1-12, and further including a battery, display, or network interface communicatively coupled to the processor through the printed circuit board.

Example 14 includes the subject matter of any of Examples 1-13, and wherein the at least one block comprises Kovar.

Example 15 includes a system comprising a package substrate; a photonic integrated circuit; and a coupler comprising at least one rigid portion; and a plurality of optical channels, wherein a portion of the plurality of optical channels are encased within the at least one rigid portion; wherein the at least one rigid portion comprises at least one feature comprising a reference point for alignment of the plurality of optical channels with waveguides of an integrated circuit die.

Example 16 includes the subject matter of any of Example 15, and further including a processor coupled to the package substrate and the photonic integrated circuit.

Example 17 includes the subject matter of any of Examples 15-16, and further including a printed circuit board coupled to the package substrate.

Example 18 includes the subject matter of any of Examples 15-17, and further including a battery, display, or network interface communicatively coupled to the processor through the printed circuit board.

Example 19 includes the subject matter of any of Examples 15-18, and wherein the at least one feature comprises a kinematic feature on a surface of the at least one rigid portion.

Example 20 includes the subject matter of any of Examples 15-19, and wherein the at least one feature comprises a fiducial.

Example 21 includes the subject matter of any of Examples 15-20, and wherein a feature of the at least one feature comprises a groove in a surface of the at least one rigid portion.

Example 22 includes the subject matter of any of Examples 15-21, and wherein a feature of the at least one feature is substantially parallel to the plurality of optical channels.

Example 23 includes the subject matter of any of Examples 15-22, and wherein a feature of the at least one feature is substantially perpendicular to the plurality of optical channels.

Example 24 includes the subject matter of any of Examples 15-23, and wherein a feature of the at least one feature extends from one side of the at least one rigid portion to an opposite side of the at least one rigid portion on a surface of the at least one rigid portion.

Example 25 includes the subject matter of any of Examples 15-24, and wherein the at least one feature comprises a first feature substantially parallel to the plurality of optical channels and a second feature substantially perpendicular to the plurality of optical channels, wherein the first feature and second feature intersect.

Example 26 includes the subject matter of any of Examples 15-26, wherein the at least one feature comprises at least one first feature on a top surface of the at least one rigid portion and at least one second feature on a bottom surface of the at least one rigid portion.

Example 27 includes an apparatus comprising at least one rigid portion; and a plurality of optical channels, wherein a portion of the plurality of optical channels are secured within the at least one rigid portion, the plurality of optical channels comprising first ends extending from the at least one rigid portion; wherein the at least one rigid portion comprises at least one feature to provide a reference point for alignment of the first ends of the plurality of optical channels with optical channels of an integrated circuit die.

Example 28 includes the subject matter of Example 27, and wherein the at least one feature comprises a kinematic feature on a surface of the at least one rigid portion.

Example 29 includes the subject matter of any of Examples 27 and 28, and wherein the at least one feature comprises a fiducial.

Example 30 includes the subject matter of any of Examples 27-29, and wherein the at least one rigid portion comprises a first block comprising glass and a second block comprising glass.

Example 31 includes the subject matter of any of Examples 27-30, and further including a package substrate coupled to the integrated circuit die.

Example 32 includes the subject matter of any of Examples 27-31, and further including a printed circuit board and a package substrate coupled to the integrated circuit die.

Example 33 includes the subject matter of any of Examples 27-32, and further including a processor coupled to the package substrate and the photonic integrated circuit.

Example 34 includes the subject matter of any of Examples 27-33, and further including a printed circuit board coupled to the package substrate.

Example 35 includes the subject matter of any of Examples 27-34, and further including a battery, display, or network interface communicatively coupled to the processor through the printed circuit board.

Example 36 includes the subject matter of any of Examples 27-35, and wherein a feature of the at least one feature comprises a groove in a surface of the at least one rigid portion.

Example 37 includes the subject matter of any of Examples 27-36, and wherein a feature of the at least one feature is substantially parallel to the plurality of optical channels.

Example 38 includes the subject matter of any of Examples 27-37, and wherein a feature of the at least one feature is substantially perpendicular to the plurality of optical channels.

Example 39 includes the subject matter of any of Examples 27-38, and wherein a feature of the at least one feature extends from one side of the at least one rigid portion to an opposite side of the at least one rigid portion on a surface of the at least one rigid portion.

Example 40 includes the subject matter of any of Examples 27-39, and wherein the at least one feature comprises a first feature substantially parallel to the plurality of optical channels and a second feature substantially perpendicular to the plurality of optical channels, wherein the first feature and second feature intersect.

Example 41 includes the subject matter of any of Examples 27-40, and wherein the at least one feature comprises at least one first feature on a top surface of the at least one rigid portion and at least one second feature on a bottom surface of the at least one rigid portion.

Example 42 includes a method comprising forming alignment features on at least one of a first rigid block and a second rigid block; encasing a plurality of optical channels between the first rigid block and the second rigid block; and aligning the plurality of optical channels with a plurality of waveguides of a photonic integrated circuit die based on the alignment features.

Example 43 includes the subject matter of Example 42, and wherein the alignment features comprise kinematic features on a surface of the first rigid block.

Example 44 includes the subject matter of any of Examples 42 and 43, and wherein the alignment features comprise fiducials.

Example 45 includes the subject matter of any of Examples 42-44, and wherein the first rigid block comprises glass.

Example 46 includes the subject matter of any of Examples 42-45, and wherein the first rigid block and the second rigid block comprise glass.

Example 47 includes the subject matter of any of Examples 42-46, and further including coupling the photonic integrated circuit die to a package substrate.

Example 48 includes the subject matter of any of Examples 42-47, and further including coupling a printed circuit board to the package substrate.

Example 49 includes the subject matter of any of Examples 42-48, and further including coupling a processor to the package substrate and the photonic integrated circuit.

Example 50 includes the subject matter of any of Examples 42-49, and further including coupling a battery, display, or network interface to the processor through the printed circuit board.

Example 51 includes the subject matter of any of Examples 42-50, and wherein an alignment feature of the alignment features comprises a groove in a surface of the first rigid block.

Example 52 includes the subject matter of any of Examples 42-51, and wherein an alignment feature of the alignment features is substantially parallel to the plurality of optical channels.

Example 53 includes the subject matter of any of Examples 42-52, and wherein an alignment feature of the alignment features is substantially perpendicular to the plurality of optical channels.

Example 54 includes the subject matter of any of Examples 42-53, and wherein an alignment feature of the alignment features extends from one side of the first rigid block to an opposite side of the first rigid block on a surface of the first rigid block.

Example 55 includes the subject matter of any of Examples 42-54, and wherein alignment features comprise a first alignment feature substantially parallel to the plurality of optical channels and a second alignment feature substantially perpendicular to the plurality of optical channels, wherein the first alignment feature and second alignment feature intersect.

Example 56 includes the subject matter of any of Examples 42-55, and wherein the alignment features comprise at least one first feature on a top surface of the first rigid block and at least one second feature on a bottom surface of the second rigid block.

Example 57 includes an apparatus comprising at least one rigid portion; and a plurality of optical channels, wherein a portion of the plurality of optical channels are secured within the at least one rigid portion, the plurality of optical channels comprising first ends extending from the at least one rigid portion; wherein the at least one rigid portion comprises a groove in a surface of the at least one block.

Example 58 includes the subject matter of Example 57, wherein the groove is to mate with a corresponding ridge of a pick head.

Example 59 includes the subject matter of any of Examples 57-58, wherein the groove is to provide a reference point for alignment of the first ends of the plurality of optical channels with optical channels of an integrated circuit die.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

1. An apparatus comprising:
at least one block comprising glass; and
a plurality of optical channels, wherein the plurality of optical channels are encased within the at least one block along a portion of a length of the plurality of optical channels, the plurality of optical channels comprising first ends connected to an optical connector and second ends extending from the at least one block;
wherein the at least one block comprises at least one feature to provide a reference point for alignment of the plurality of optical channels with optical channels of an integrated circuit die.

2. The apparatus of claim 1, wherein the at least one feature comprises a kinematic feature on a surface of the at least one block.

3. The apparatus of claim 1, wherein the at least one feature comprises a fiducial.

4. The apparatus of claim 1, wherein a feature of the at least one feature comprises a groove in a surface of the at least one block.

5. The apparatus of claim 1, wherein a feature of the at least one feature is substantially parallel to the plurality of optical channels.

6. The apparatus of claim 1, wherein a feature of the at least one feature is substantially perpendicular to the plurality of optical channels.

7. The apparatus of claim 1, wherein a feature of the at least one feature extends from one side of the at least one block to an opposite side of the at least one block on a surface of the at least one block.

8. The apparatus of claim 1, wherein the at least one feature comprises a first feature substantially parallel to the plurality of optical channels and a second feature substantially perpendicular to the plurality of optical channels, wherein the first feature and second feature intersect.

9. The apparatus of claim 1, wherein the at least one feature comprises at least one first feature on a top surface of the at least one block and at least one second feature on a bottom surface of the at least one block.

10. The apparatus of claim 1, further comprising the integrated circuit die.

11. A system comprising:
a package substrate;
a photonic integrated circuit; and
a coupler comprising:
at least one rigid portion; and
a plurality of optical channels, wherein a portion of the plurality of optical channels are encased within the at least one rigid portion;
wherein the at least one rigid portion comprises at least one feature comprising a reference point for alignment of the plurality of optical channels with waveguides of an integrated circuit die.

12. The system of claim 11, further comprising a processor coupled to the package substrate and the photonic integrated circuit.

13. The system of claim 12, further comprising a printed circuit board coupled to the package substrate.

14. The system of claim 13, further comprising a battery, display, or network interface communicatively coupled to the processor through the printed circuit board.

15. An apparatus comprising:
at least one rigid portion; and
a plurality of optical channels, wherein a portion of the plurality of optical channels are secured within the at least one rigid portion, the plurality of optical channels extending from the at least one rigid portion;
wherein the at least one rigid portion comprises a groove in a surface of the at least one rigid portion.

16. The apparatus of claim 15, wherein the groove is to mate with a corresponding ridge of a pick head.

17. The apparatus of claim 15, wherein the groove is to provide a reference point for alignment of the plurality of optical channels with optical channels of an integrated circuit die.

18. The apparatus of claim 15, wherein the at least one rigid portion comprises a first block comprising glass and a second block comprising glass.

19. The apparatus of claim 17, further comprising a package substrate coupled to the integrated circuit die.

20. The apparatus of claim 19, further comprising a printed circuit board coupled to the package substrate.
